(19) United States
(12) Patent Application Publication
(10) Pub. No.: US 2025/0073865 A1
(43) Pub. Date: Mar. 6, 2025

(54) Pass-through Socket Set With Impact Adaptor

(71) Applicant: Klein Tools, Inc., Lincolnshire, IL (US)

(72) Inventor: Austin Minor, Aledo, TX (US)

(73) Assignee: Klein Tools, Inc., Lincolnshire, IL (US)

(21) Appl. No.: 18/819,816

(22) Filed: Aug. 29, 2024

Related U.S. Application Data
(60) Provisional application No. 63/536,060, filed on Aug. 31, 2023.

(51) Int. Cl. B25B 21/00; B25B 13/46; B25B 23/00

(52) U.S. Cl. CPC B25B 21/004; B25B 13/462; B25B 23/0035

(57) ABSTRACT

A pass-through socket set 1 includes a ratchet wrench, a plurality of nut driving sockets, a socket driving extension, and an impact driver adaptor. Each of the sockets and the extension can be engaged in the ratchet wrench 12 to be driven thereby, with the extension also being able to engage each of the sockets to transfer torque from the wrench to the socket when the extension is engaged in the. Furthermore, each of the sockets and the extension 16 can be engaged in the adaptor 18 to allow the socket to be driven/rotated by a power driver, such as any conventional and known powered impact driver, powered drill, or powered screwdriver, by engaging a shank of the adaptor in the quick connect or chuck of the power driver.

### CROSS-REFERENCE TO RELATED APPLICATIONS

This application claims priority to U.S. Ser. No. 63/536,060 filed Aug. 31, 2023, titled Pass-through Socket Set With Impact Adaptor, the entire disclosure of which is incorporated herein by reference.

### BACKGROUND OF THE DISCLOSURE

The present disclosure relates to nut drivers for threaded fasteners, and more specifically, to socket sets that allow a threaded rod or shank to pass completely through the socket and driver wrench while the socket is used to thread a nut on to or off of the threaded rod or shank. While pass through socket sets are known, there is always room for improvement, including room to increase the versatility provided by such socket sets.

### BRIEF SUMMARY OF THE DISCLOSURE

Non-limiting examples of features that could be claims from this disclosure are provided below:
1. A pass-through socket tool set including an adaptor to allow attachment to a power driver; the tool set comprising:
a ratchet wrench comprising;
a ratchet head,
a handle extending from the ratchet head to allow a user to apply a torque force to the ratchet head, and
socket drive member mounted in the ratchet head to selectively transfer torque from the ratchet head to a socket engaged in the socket drive member, the socket drive member having a pass-through opening including an radially inwardly facing socket drive surface centered on a drive axis and configured to transfer torque from the drive member to a socket engaged in the socket drive member;
a first nut driving socket having a first drive end, a first driven end, and a first pass-through opening extending along a first longitudinal axis and sized to allow a threaded rod or shank of a predetermined diameter to extend through the first nut driving socket from the first drive end to the first driven end, the first drive end having a radially inwardly facing surface centered on the first longitudinal axis and configured to drivingly engage a hexagonal shaped exterior of a first size on a threaded nut, the first driven end having an radially outwardly facing surface centered on the first longitudinal axis and configured to be drivingly engaged by the socket drive surface of the drive member;
a second nut driving socket having a second drive end, a second driven end, and a second pass-through opening extending along a second longitudinal axis and sized to allow a threaded rod or shank of the predetermined diameter to extend through the second nut driving socket from the second drive end to the second driven end, the second drive end having a radially inwardly facing surface centered on the second longitudinal axis and configured to drivingly engage a hexagonal shaped exterior of a second size on a threaded nut, the second size being larger than the first size, the second driven end having an radially outwardly facing surface centered on the second longitudinal axis and configured to be drivingly engaged by the socket drive surface of the drive member;
a socket driving extension having a third drive end, a third driven end, and a third pass-through opening centered on a third longitudinal axis and sized to allow a threaded rod or shank of the predetermined diameter to extend through the socket driving extension from the third drive end to the third driven end, the third drive end having a radially inwardly facing surface centered on the third longitudinal axis and configured to drivingly engage the radially outwardly facing surface of each of the first and second driven ends, the third driven end having an radially outwardly facing surface centered on the third longitudinal axis and configured to be drivingly engaged by the socket drive surface of the drive member; and
an adaptor having a shank extending from a fourth drive end, the shank having an exterior surface centered on a fourth longitudinal axis and configured to be drivingly engaged by a quick connect of a power driver, the fourth drive end having a radially inwardly facing surface centered on the fourth longitudinal axis and configured to drivingly engage the radially outwardly facing surface of each of the first, second and third driven ends.
2. The tool set of claim 1 wherein the socket drive surface and the radially inwardly facing surface of the third drive end have identical transverse profiles.
3. The tool set of claim 1 wherein the radially outwardly facing surface of each of the first, second and third driven ends have identical transverse profiles.
4. The tool set of claim 1 wherein each of the socket drive surface and the radially inwardly facing surface is defined by twelve axially extending grooves that are equally circumferentially spaced from each other.
5. The tool set of claim 1 wherein the radially outwardly facing surface of each of the first, second and third driven ends is defined by twelve axially extending teeth that are equally circumferentially spaced from each other.
6. The tool set of claim 1 wherein the exterior surface of the shank has a hexagonally shaped transverse profile.
7. The tool set of claim 6 wherein the shank includes an annular groove.
8. The tool set of claim 1 wherein each of the radially inwardly facing surfaces of the first and second drive ends has a hexagonal shaped transverse profile.
9. The tool set of claim 1 further comprising a plurality of additional nut driving sockets, each having an additional drive end, an additional driven end, and an additional pass-through opening extending along an additional longitudinal axis and sized to allow a threaded rod or shank of the predetermined diameter to extend through the additional nut driving socket from the additional drive end to the additional driven end, each of the additional drive ends having a radially inwardly facing surface centered on the additional longitudinal axis and configured to drivingly engage a hexagonal shaped exterior of an additional size on a threaded nut, each of the additional size being different than any of the other additional sizes and different than the first and second size, each of the additional driven ends having an radially outwardly facing surface centered on the additional longitudinal axis and configured to be drivingly engaged by each of the socket drive surface of the drive member, the radially inwardly facing surface of the third drive end, and the radially inwardly facing surface of the fourth drive end.
10. The tool set of claim 1 wherein:
each of the socket drive surface of the drive member, the radially inwardly facing surface of the third drive end, and the radially inwardly facing surface of the fourth drive end has an annular groove receiving a circular shaped retaining ring; and
each of the radially outwardly facing surface of each of the first, second, and third driven ends includes at least on relief configured to receive a portion of each of the retaining rings when the driven ends are drivingly engaged with each of the socket drive surface of the drive member, the radially inwardly facing surface of the third drive end, and the radially inwardly facing surface of the fourth drive end.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is an exploded perspective view of a pass-through socket set according to this disclosure;

FIG. 2 is an enlarged, perspective view showing a portion of a ratchet wrench of the socket set of FIG. 1;

FIG. 3 is an exploded side view of an impact driver adaptor, a socket extension, and a socket of the socket set of FIG. 1;

FIG. 4 is a view similar to FIG. 3 but showing the longitudinal cross-section of the each of the component of FIG. 3;

FIG. 5 is a side view showing the impact driver adaptor, socket extension, and socket of FIGS. 1, 3, and 4, plus additional sockets for the socket set of FIG. 1, and with a schematical representation of a power driver and associated quick connect or chuck.

### DETAILED DESCRIPTION OF PREFERRED EMBODIMENTS

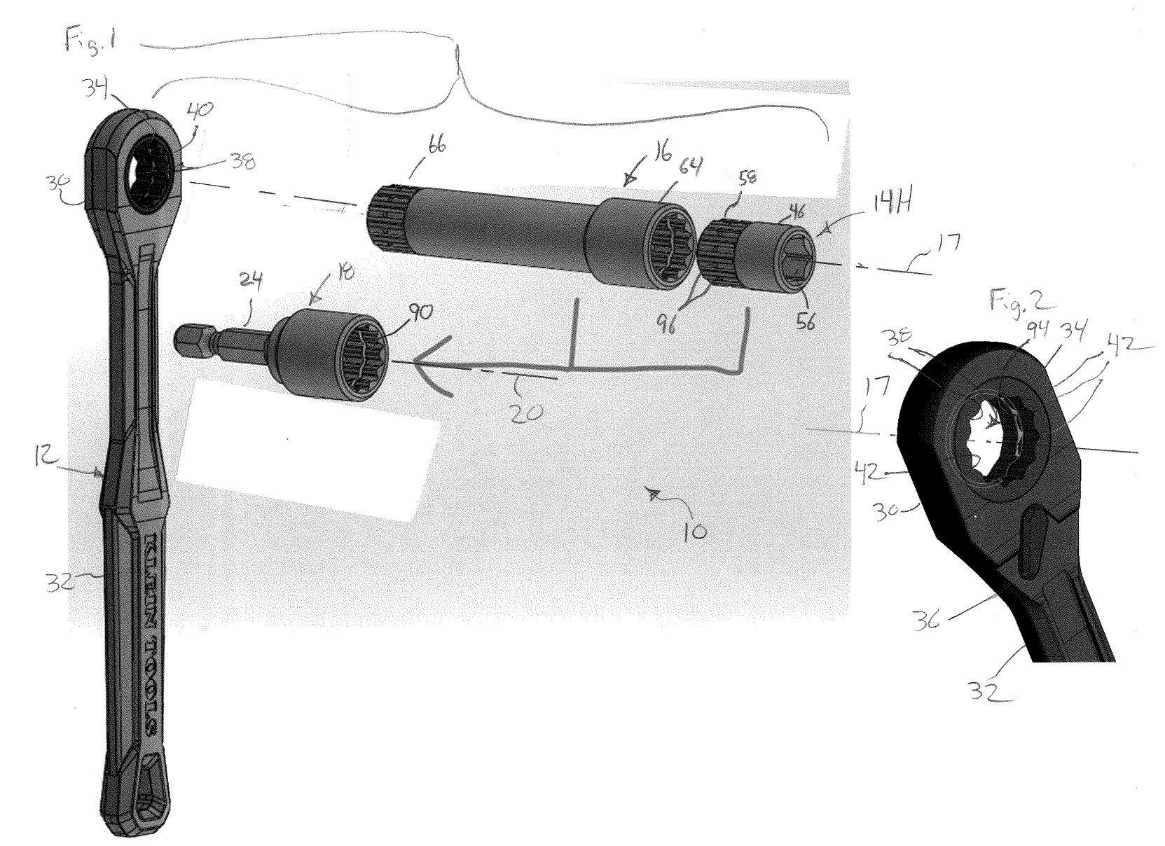

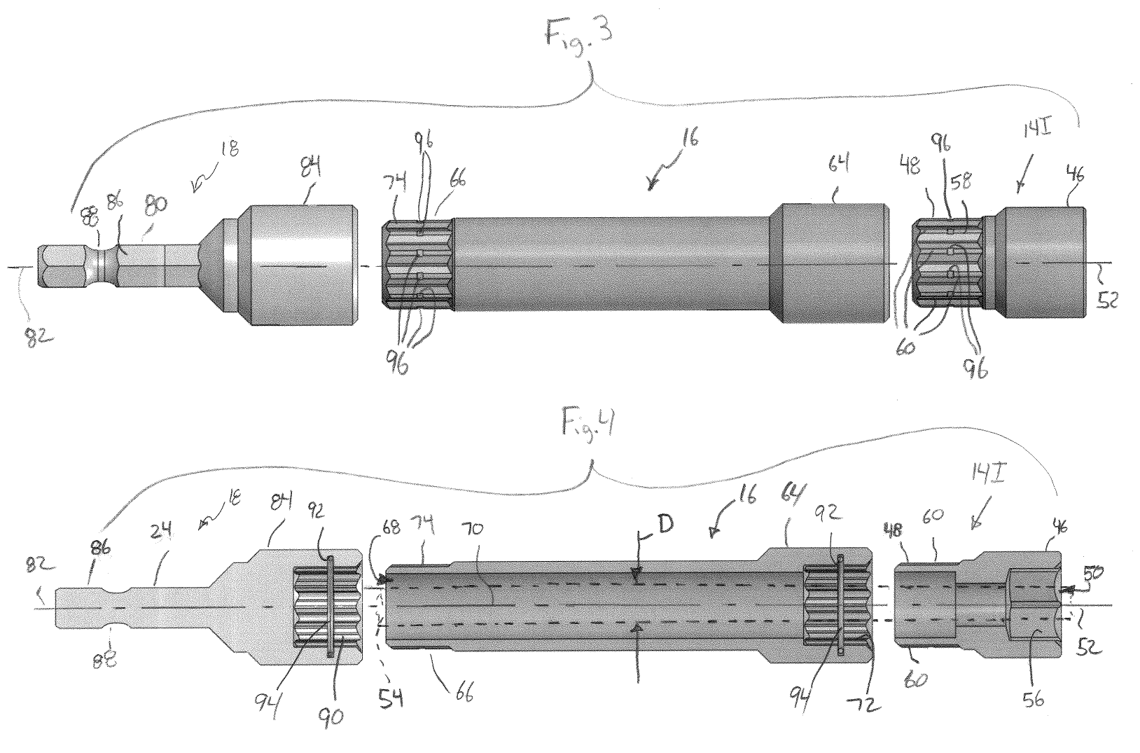

As best seen in FIGS. 1 and 5, a pass-through socket set 10 according to this disclosure is shown and includes a ratchet wrench 12, a plurality of nut driving sockets 14A-14K, a socket driving extension 16, and an impact driver adaptor 1. As best seen in FIG. 1, each of the sockets 14A-14H and the extension 16 can be engaged in the ratchet wrench 12 to be driven thereby about a drive axis 17, with the extension 16 also being able to engage each of the sockets 14A-14H to transfer torque from the wrench 12 to the socket 14A-14H when the extension 16 is engaged in the wrench 12 for driven rotation about the axis 17. Furthermore, to increase the functionality and versatility of the socket set 10, each of the sockets 14A-14H and the extension 16 can be engaged in the adaptor 18 to allow the sockets 14A-14H to be driven/rotated by a power driver 22 about another drive axis 20, such as any conventional and known powered impact driver, powered drill, or powered screwdriver, by engaging a shank 24 of the adaptor 18 in the quick connect or chuck 26 of the power driver 22. In the illustrated and preferred embodiments, all of the components are impact rated for drivers.

The ratchet wrench 12 includes a ratchet head 30, a handle 32 extending from the ratchet head 30 to allow a user to apply a torque force to the ratchet head 30, and a socket drive member 34 mounted in the ratchet head 30 to selectively transfer torque from the ratchet head 30 to the extension 16 and/or any one of the sockets 14A-14H engaged in the socket drive member 34. The head will mount and contain any suitable ratchet mechanism, many of which are known, and preferably any suitable ratchet mechanism that includes a selector switch 36 that allows a user to select which rotational direction transfers torque from the drive member 34 and which rotational direction allows the drive member to “free wheel” relative to the head 30, again many of which are known. Because it isn't critical to an understanding of the inventive concepts disclosed herein, further details of any particular configuration or type of ratchet mechanism will not be discussed herein. Furthermore, while a ratchet wrench is highly preferred, it should be understood that in some embodiments of the socket set 10 the wrench 10 can be a non-ratcheting wrench or driver handle with the drive member 34 being fixed against rotation in both direction relative to the remainder of the wrench or handle 10, and could even be a unitary part of the remainder of the wrench 10 formed from the same piece of material as the remainder of the wrench 10. The socket drive member 34 has a pass-through opening 38 that includes an radially inwardly facing socket drive surface 40 centered on the drive axis 17 and configured to transfer torque from the drive member 34 to the extension 16 and/or any one of the sockets 14A-14H engaged in the socket drive member 34. In this regard, in the illustrated and preferred embodiment, the radially inwardly facing drive surface 40 is defined by twelve axially extending grooves 42 that are equally circumferentially spaced from each other and that extend parallel to the drive axis 17.

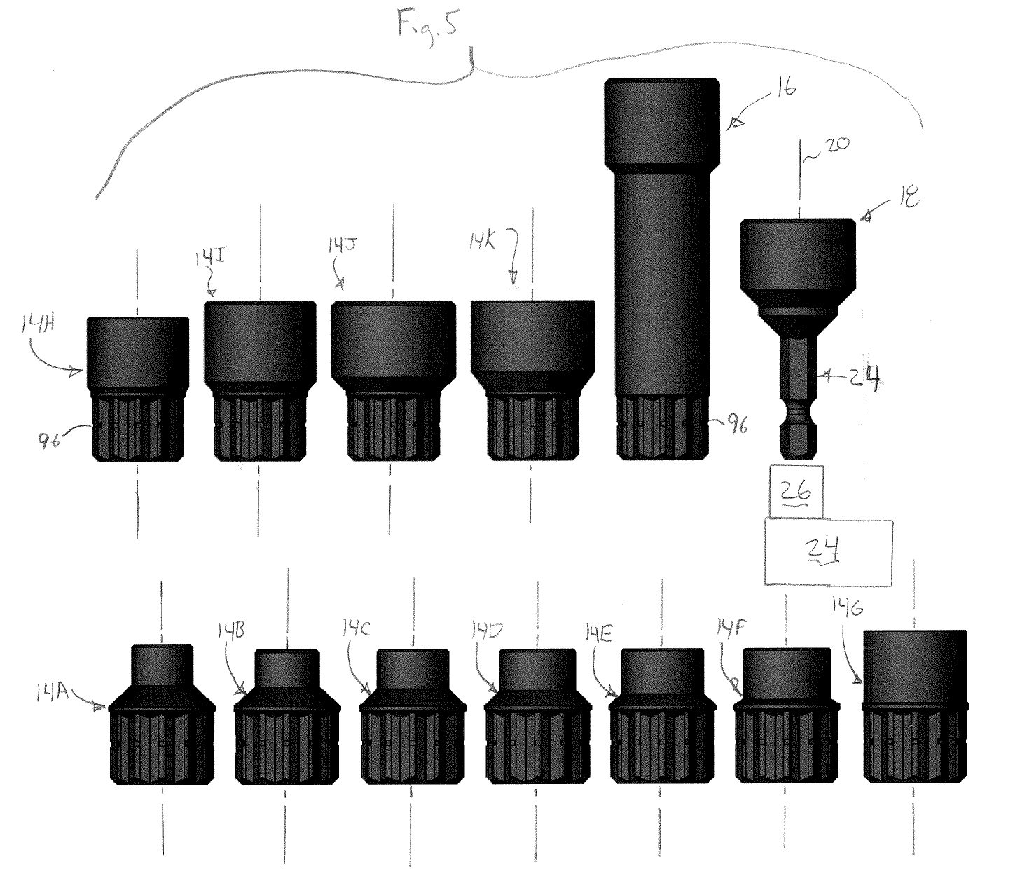

Each of the sockets 14A-14K are of identical construction with the exception that each socket is sized to drive a different sized hex nut. Accordingly, the sockets will all be described in detail with respect to the socket 14I shown in FIGS. 3 and 4. As shown in FIGS. 3 and 4, each of the sockets 14A-14K, have drive end 46, a driven end 48, and a pass-through opening 50 extending along a longitudinal socket axis 52. The pass-through opening 50 is sized to allow a threaded rod or shank 54 (shown in phantom in FIG. 4) of a predetermined diameter D to extend through the socket 14A-14K from the drive end 46 to the driven end 48. The drive end 46 of each socket 14A-14K has a radially inwardly facing surface 56 centered on the socket axis 52 and configured to drivingly engage a hexagonal shaped exterior of a specific size on a hexagonal nut, with the specific size for each socket 14A-14K being different from the specific size on any of the other sockets 14A-14K in the illustrated embodiment so that the sockets can drive 11 different sizes of hexagonal nuts. In the illustrated and preferred embodiment, each of the inwardly facing surfaces 56 has a hexagonal shaped transvers profile, as is common for nut driving sockets, but it should be appreciated that any suitable shape, many of which are known, can be used to for the inwardly facing surfaces 56 to drive/transfer torque to a hexagonal nut. The driven end 48 of each socket 14A-14K has a radially outwardly facing surface 58 centered on the socket axis 52 and configured to be drivingly engaged by the socket drive surface 40, with the illustrated embodiment showing the surface 58 as having a transverse profile shape that conforms to the transverse profile shape of the socket drive surface 40, including 12 ridges 60 that are equally circumferentially spaced from each other and extend parallel to the axis 52 to be received within a corresponding one of the grooves 42. It should be appreciated that the surface 58 on each of the sockets 14A-14K is of identical size and configuration in the illustrated and preferred embodiments. It should also be understood that other transverse profile shapes could be used to transfer torque between the surfaces 40 and 50.

The socket driving extension 16 includes a drive end 64, a driven end 66, and a pass-through opening 68 extending along a longitudinal axis 70 from the drive end 64 to the driven end 68. The pass-through opening 68 is sized to allow the threaded rod 54 of the predetermined diameter D to extend through the extension 16 from the drive end 64 to the driven end 68. The drive end 64 has a radially inwardly facing surface 72 centered on the axis 70 and configured to drivingly engage each of the surfaces 60 on each of the sockets 14A-14K. In this regard, in the illustrated and preferred embodiment, the surface 72 has the same transverse profile as the socket drive surface 40, including having twelve grooves that are equally circumferentially spaced from each other and that extend parallel to the axis 70. The driven end 66 has a radially outwardly facing surface 74 centered on the axis 70 and configured to be drivingly engaged by the socket drive surface 40. In this regard, in the illustrated and preferred embodiments, the surface 74 is of identical size and configuration as each of the surfaces 48 on the sockets 14A-14K, including having 12 including 12 ridges that are equally circumferentially spaced from each other and extend parallel to the axis 70 to be received within a corresponding one of the grooves 42.

The adapter 18 includes the shank 24 extending along a longitudinal axis 82 from a drive end 84. The shank 80 has an exterior surface 86 configured to be drivingly engaged in the quick connect or chuck 26 of the power driver to be driven/rotated by the power driver 22 about another drive axis 20 and the adapter axis 18. Again, in this regard, any conventional and known powered impact driver, powered drill, or powered screwdriver having any conventional quick connect or chuck 26 can be used. In the illustrated and preferred embodiment, the surface 86 has a hexagonal shaped transverse profile that is interrupted by an annular groove 88 as is conventional for shanks configured to be engaged in the quick connect of an impact driver. The driven end 84 has a radially inwardly facing surface 90 centered on the axis 82 and configured to drivingly engage the surface 74 on the extension 16 and each of the surfaces 60 on each of the sockets 14A-14K. In this regard, in the illustrated and preferred embodiment, the surface 90 has the same transverse profile as the socket drive surface 40 and the inwardly facing surface 72, including having twelve grooves that are equally circumferentially spaced from each other and that extend parallel to the axis 82. It can be seen that, in the illustrated and preferred embodiment, the surface 90 has the same size and configuration as the surface 72.

Each of the surfaces 40, 72, and 90 includes a radially inwardly opening annular groove 92 that receives a circular, c-shaped retaining ring 94, and each of the surfaces 58 and 74 includes a plurality of reliefs 96 that releasably receive the ring 94 when the surfaces 58 and 74 are engaged with each of the surfaces 40, 72, and 90 to releasably retain the corresponding socket 14A-14K or extension 16 in the corresponding one of the drive member 34, adaptor 18, or extension 16.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the tool set 10 are shown in the figures, it should be understood that this disclosure anticipates variations in the specific details of each of the disclosed components and features of the tool set 10 and that no limitation to a specific form, configuration, or detail is intended unless expressly and specifically recited in an appended claim.

For example, while specific and preferred forms have been shown for the surfaces 40, 56, 58, 72, 74, and 90, in some applications other forms that can be drivingly engaged to transfer torque may be advantageous. Similarly, while a preferred configuration has been shown for the releasable retention features 92, 94, and 96, in some applications other configurations for releasable retention may be advantageous. Furthermore, while a specific number of sockets 14A-14K have been shown, in some applications a single socket 14 or more sockets 14 may be utilized. Accordingly, no limitation to specific features is intended unless expressly recited in an appended claim.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A pass-through socket tool set including an adaptor to allow attachment to a power driver; the tool set comprising:
a ratchet wrench comprising;
a ratchet head,
a handle extending from the ratchet head to allow a user to apply a torque force to the ratchet head, and
a socket drive member mounted in the ratchet head to selectively transfer torque from the ratchet head to a socket engaged in the socket drive member, the socket drive member having a pass-through opening including an radially inwardly facing socket drive surface centered on a drive axis and configured to transfer torque from the drive member to a socket engaged in the socket drive member;
a first nut driving socket having a first drive end, a first driven end, and a first pass-through opening extending along a first longitudinal axis and sized to allow a threaded rod or shank of a predetermined diameter to extend through the first nut driving socket from the first drive end to the first driven end, the first drive end having a radially inwardly facing surface centered on the first longitudinal axis and configured to drivingly engage a hexagonal shaped exterior of a first size on a threaded nut, the first driven end having an radially outwardly facing surface centered on the first longitudinal axis and configured to be drivingly engaged by the socket drive surface of the drive member;
a second nut driving socket having a second drive end, a second driven end, and a second pass-through opening extending along a second longitudinal axis and sized to allow a threaded rod or shank of the predetermined diameter to extend through the second nut driving socket from the second drive end to the second driven end, the second drive end having a radially inwardly facing surface centered on the second longitudinal axis and configured to drivingly engage a hexagonal shaped exterior of a second size on a threaded nut, the second size being larger than the first size, the second driven end having an radially outwardly facing surface centered on the second longitudinal axis and configured to be drivingly engaged by the socket drive surface of the drive member;
a socket driving extension having a third drive end, a third driven end, and a third pass-through opening centered on a third longitudinal axis and sized to allow a threaded rod or shank of the predetermined diameter to extend through the socket driving extension from the third drive end to the third driven end, the third drive end having a radially inwardly facing surface centered on the third longitudinal axis and configured to drivingly engage the radially outwardly facing surface of each of the first and second driven ends, the third driven end having an radially outwardly facing surface centered on the third longitudinal axis and configured to be drivingly engaged by the socket drive surface of the drive member; and
an adaptor having a shank extending from a fourth drive end, the shank having an exterior surface centered on a fourth longitudinal axis and configured to be drivingly engaged by a quick connect of a power driver, the fourth drive end having a radially inwardly facing surface centered on the fourth longitudinal axis and configured to drivingly engage the radially outwardly facing surface of each of the first, second and third driven ends.

2. The tool set of claim 1 wherein the socket drive surface and the radially inwardly facing surface of the third drive end have identical transverse profiles.

3. The tool set of claim 1 wherein the radially outwardly facing surface of each of the first, second and third driven ends have identical transverse profiles.

4. The tool set of claim 1 wherein each of the socket drive surface and the radially inwardly facing surface is defined by twelve axially extending grooves that are equally circumferentially spaced from each other.

5. The tool set of claim 1 wherein the radially outwardly facing surface of each of the first, second and third driven ends is defined by twelve axially extending teeth that are equally circumferentially spaced from each other.

6. The tool set of claim 1 wherein the exterior surface of the shank has a hexagonally shaped transverse profile.

7. The tool set of claim 6 wherein the shank includes an annular groove.

8. The tool set of claim 1 wherein each of the radially inwardly facing surfaces of the first and second drive ends has a hexagonal shaped transverse profile.

9. The tool set of claim 1 further comprising a plurality of additional nut driving sockets, each having an additional drive end, an additional driven end, and an additional pass-through opening extending along an additional longitudinal axis and sized to allow a threaded rod or shank of the predetermined diameter to extend through the additional nut driving socket from the additional drive end to the additional driven end, each of the additional drive ends having a radially inwardly facing surface centered on the additional longitudinal axis and configured to drivingly engage a hexagonal shaped exterior of an additional size on a threaded nut, each of the additional size being different than any of the other additional sizes and different than the first and second size, each of the additional driven ends having an radially outwardly facing surface centered on the additional longitudinal axis and configured to be drivingly engaged by each of the socket drive surface of the drive member, the radially inwardly facing surface of the third drive end, and the radially inwardly facing surface of the fourth drive end.

10. The tool set of claim 1 wherein:
each of the socket drive surface of the drive member, the radially inwardly facing surface of the third drive end, and the radially inwardly facing surface of the fourth drive end has an annular groove receiving a circular shaped retaining ring; and
each of the radially outwardly facing surface of each of the first, second, and third driven ends includes at least on relief configured to receive a portion of each of the retaining rings when the driven ends are drivingly engaged with each of the socket drive surface of the drive member, the radially inwardly facing surface of the third drive end, and the radially inwardly facing surface of the fourth drive end.
